(19) United States
(12) Patent Application Publication
(10) Pub. No.: US 2004/0234772 A1
(43) Pub. Date: Nov. 25, 2004

(54) Slip-and marking-resistant floor covering

(76) Inventors: Adrian John Shortland, Birmingham (GB); Karen Alexandra Masters, Hertfordshire (GB)

Correspondence Address: BAKER & BOTTS, 30 ROCKEFELLER PLAZA, NEW YORK, NY, 10112

(21) Appl. No.: 10/483,852

(22) PCT Filed: Jul. 30, 2002
(86) PCT No.: PCT/GB02/03468

(30) Foreign Application Priority Data
Aug. 1, 2001 (GB) 0118738.4

(51) Int. Cl. B32B 27/36

(52) U.S. Cl. 428/413; 428/480; 428/500

(57) ABSTRACT

The present invention provides a slip resistant flooring material including a low surface tension additive to improve resistance to marking.

The present invention relates to the treatment of flooring to improve mark resistance and removal, the marks being caused by shoe soles/heels, especially when said flooring is slip-resistant flooring.

Many floor materials are susceptible to marking caused by shoe sole materials and especially the base of the heel. The exact mechanism -by which heel marking occurs is not fully understood but the cause is thought to be high friction between the base of the heel and a floor surface as the heel is brushed along the floor due to slipping or normal walking action. This causes localised shear forces and localised raised temperatures at the shoe-floor interface. This in turn causes some of the heel material to be deposited on the floor surface.

The intensity of marks depends on a number of factors, including the nature of the shoe material, the nature of the floor material and its surface tension, and any contamination such as water or grease present.

The current methods of removing heel marks include rubbing with cloths or abrasive media such as wire wool. This can be time consuming and may require considerable effort.

There are currently known methods of treating the floor surface by applying various finishes to the surface which increase resistance to heel marks. One problem with these finishes is that the flooring has reduced slip resistance, especially in wet conditions, as the material used for the finishes cause a reduction in surface tension and friction, and there is insufficient surface roughness for grip.

Slip resistant flooring is also known, whereby shoes do not slip along it as frequently as along other floors, and therefore the number of marks caused by slipping is reduced. One problem with this flooring is that marks are still caused by normal walking and scuffing: these marks are very difficult to remove.

A solution to these problems has been sought.

According to the invention there is provided a slip resistant flooring material including a low surface tension additive to improve resistance to marking.

Slip resistant flooring material is known in various forms. Any kind of slip resistant flooring material which includes a particulate material which is at least partially proud of an upper surface of the flooring material may be used with this invention. A low surface tension additive has previously not been included in slip resistant flooring because if the fear that its inclusion would reduce its slip resistance. It has been found that the inclusion of a low surface tension additive in a slip resistant flooring material especially in the amounts given below reduces heel marking without affecting the slip resistance. This is surprising because it would have been expected that the inclusion of a low surface tension additive (e.g. a wax or a silicone oil) would have made the flooring material slippery but this has not been found to be the case particularly when the additive is included in an amount suitable to improve resistance to marking without substantially decreasing the slip resistance of the flooring material.

The flooring material is preferably a plastics flooring material. The flooring material generally includes a base layer.

The base layer preferably includes a support; the support is preferably a glass fibre reinforced non-woven support.

Preferably the base layer includes PVC, a polyurethane, an epoxy resin, a plasticised acrylic, and/or a polyester. More preferably, the base layer includes a plastics material such as a PVC plastisol or a plasticised acrylie material. The base layer preferably includes a second particulate material dispersed therein to further improve the non-slip properties of the flooring material or to enhance the wear resistance of the flooring material. The base layer may optionally contain decorative elements such as a pigment and/or PVC chips.

The base portion may be made up of one or more layers of plastics material; preferably up to three layers are envisaged.

Optionally the base layer is provided with a coating layer which forms an upper layer of the flooring material. The coating layer preferably includes a thermoplastic or a cross-linkable polymer or copolymer. For the cross-linkable polymer or copolymer, cross-linking may be effected by condensation or by a free radical route such as using UV radiation. Examples of suitable polymers or copolymers include PvdF, a polyester, polyurethane, or acrylic polymer or copolymer, an epoxy resin, and/or an olefin/modified olefin copolymer. More preferably the coating portion includes an acrylic polymer. Most preferably the coating portion includes a mixture of an acrylic polymer with PvdF.

Optionally the coating layer further includes additives commonly used in the art such as a UV stabiliser, a biocide, and/or a flow aid such as fumed silica.

Generally the low surface tension additive is present in the upper layer of the flooring material. Where the flooring material comprises only base layer(s), the additive is present in the upper base layer. Where the flooring material comprises a coating layer forming an upper layer, the additive is preferably present only in the coating layer.

Preferably the low surface tension additive is a wax or a silicone oil. Examples of suitable waxes include a polyolefin such as a polyethylene and/or polypropylene powder (for example Grilonit MA68022 manufactured by EMS-Chemie AG), polytetrafluoroethylene (PTFE), a Fischer-Tropsch wax. Where the additive is a wax, it is preferably a melt blend of polyethylene and PTFE in powder form (for example Lanco wax TF1778 which is a micronised PTFE modified polyethylene wax manufactured by Langer & Co GmbH).

Preferably the flooring material also includes a particulate material. This is preferably a grit; more preferably it is one or more of a number of types of hard particles including silicon carbide, a silica (e.g. quartz, a coloured or natural sand or a flint), aluminium oxide and/or emery. The particulate material is preferably partially embedded in the base layer.

The flooring material is preferably embossed.

According to the invention there is also provided a first method of manufacturing a slip resistant flooring material which method includes the steps of providing a base layer including a low surface tension additive; and curing the layer.

Preferably the base layer includes a particulate material. The particulate material when present is preferably partially proud of the base layer to enhance the slip resistant properties of the flooring material.

According to the invention there is provided a second method of manufacturing a slip resistant flooring material which method includes the steps of providing a base layer, applying a coating layer including a low surface tension additive, and heating the layers.

The second method of the invention preferably includes the step of increasing the viscosity of the base layer before the step of applying the coating layer.

The coating layer is preferably applied as a powder. The powder preferably includes a thermoplastic polymer or copolymer, a thermoset polymer or copolymer, and/or a polymer or copolymer which is cured by radiation.

The powder is optionally manufactured by extrusion. This involves melting the components and mixing them (melt mixing) under shear before cooling the material and grinding it to a powder suitable for application to the floor substrate.

The low surface tension additive is optionally incorporated into the coating layer by melt mixing at the extrusion stage. Alternatively, if the low surface tension additive is a powdered wax, it may be incorporated by blending it with the ground coating layer powder in a simple manner.

The most preferred method of incorporating the low surface tension additive into the coating is the melt mixing method described above, as this gives good distribution and dispersion of the low surface tension additive.

Where the additive is a wax, it is preferably in powder form when it is applied as part of a coating layer. This is advantageous as powders are easy to mix together.

The particle size of the low surface tension additive may be up to 30 μm, and most preferably in the range 2-5μm.

The additive must be of lower surface tension than any other component of the coating material such that the attractive forces between molecules of the additive and of the coating must be sufficiently low that the additive is incompatible with the coating material. Preferably it is sufficiently incompatible such that it migrates to the upper surface of the layer when the coating is heated. This is advantageous because the low surface tension additive can only prevent marking if it is in high concentrations at the surface, and this causes the surface of the flooring to have a low surface tension, which also helps prevent heel marking.

The amount of low surface tension additive necessary are dependent on the method of incorporation, as well as the low surface tension additive and coating material used. If the preferred materials and preferred method of incorporation are used the level of low surface tension additive used is preferably in the range of from 0.1% to 4% by weight, more preferably from 0.2% to 2% by weight, most preferably about 2% by weight. Using different materials and methods of incorporation may require larger proportions of low surface tension additive to be used to achieve the same results.

The invention is further illustrated with reference to the following examples which are not intended to limit the scope of the invention claimed.

### PREPARATIVE EXAMPLE 1

Plastisols typically having the formulations given in Table 1 were produced as described below.

TABLE 1
Plastisol Formulations

| | A. | B. |
|---|---|---|
| | Weight/kg | Weight/kg |
| Solvic 380NS | 15 | 20 |
| Solvic 266SF | 5 | — |
| Jayflex DIDP | 6.5 | 6.5 |
| Microdol H155 | 10 | 5 |
| Viscobyk 4040 | — | 0.4 |
| BZ505 | 0.3 | 0.4 |
| ABF2 ESBO | 0.2 | 0.2 |
| Blue BLP pigment | 0.02 | 0.02 |

Wherein Solvic 380NS and Solvic 266SF are PVC polymers manufactured by Solvay; Jayflex DIDP is a di-isodecyl phthalate plasticiser manufactured by Exxon; Microdol H155 is a calcium magnesium carbonate manufactured by Omya; Viscobyk 4040 is a blend of aliphatic hydrocarbons with a neutral wetting and dispersing component manufactured by BYK Chemie; BZ505 is a liquid barium zinc preparation containing organic barium compounds and phosphite manufactured by Witco; ABF2 ESBO is a solution of 10,10′ oxybisphenoxyarsine in epoxidised soya bean oil manufactured by Akcros Chemicals; Blue BLP pigment is a phthalocyanine blue pigment manufactured by Ciba Pigments.

In each case, the ingredients were weighed in to a 50 litre steel vessel and mixed by a Zanelli MLV/50 mixer using a trifoil shaft at 100 rpm for 4 minutes and a dissolver shaft at 1800 rpm for 2 minutes. Aluminium oxide particles (from Washington Mills) size F40 (FEPA Standard 42-GB-1984 measurement) were weighed into each plastisol (10% w/w) and mixed.

In the case of plastisol B, this plastisol was also used to make PVC chip by spreading a sample of this plastisol at 0.6 mm using ‘knife over bed’ on to a siliconized release paper and fusing it for 2 minutes at 180° C. This material was then removed from the release paper and passed through a TRIA granulator (model no. 40-16/TC-SL) fitted with a 2 mm screen to produce PVC chips of B of nominal size 2 mm and thickness 0.6 mm.

### PREPARATIVE EXAMPLE 2

Powder coatings C, D and E comprising the ingredients given in Table 2 were produced as described below.

TABLE 2
Powder Coating Formulations C, D and E

| | C. | D. | E. |
|---|---|---|---|
| | Weight/kg | Weight/kg | Weight/kg |
| Uralac P2200 | 10 | — | — |
| Epikote 1055 | — | 10 | — |
| Uvecoat 2000 | — | — | 10 |
| Araldite PT810 | 1.1 | — | — |
| Epikure 108FF | — | 0.45 | — |
| Irgacure 651 | — | — | 0.25 |
| Byk 362P | 0.17 | 0.1 | — |
| Benzoin | 0.08 | — | 0.05 |
| Lanco wax TF1778 | 0.2 | | 0.2 |
| Grilonit MA 68022 | | 0.1 | |

Uralac P2200 is a saturated, carboxylated polyester resin manufactured by DSM. Epikote 1055 is an epoxy resin manufactured by Shell Chemicals. Uvecoat 2000 is a polyester resin containing (meth)acrylic double bonds manufactured by UCB Chemicals, Belgium. Araldite PT810 is a triglycidylisocyanurate product manufactured by Ciba Geigy. Epikure 108FF is a dicyandiamide curing agent manufactured by Shell Chemicals. Irgacure 651 is a benzylketal curing agent manufactured by Ciba Geigy. Benzoin was obtained from Aldrich Chemicals. Lanco wax TF1778 is a micronised PTFE modified polyethylene wax manufactured by Langer & Co GmbH. Grilonit Mass. 68022 is a polyolefin wax manufactured by EMS-Chemie AG.

Polyester based coating C was prepared as follows. The ingredients were weighed, and then blended by being tumbled together. The blend was then passed into a Buss Ko-Kneader PLK 46 extruder (barrel temperature 120° C.; screw temperature 50° C.; screw speed 60rpm). The extrudate was cooled, crushed and sieved to a particle size not exceeding 100 μm.

Epoxy resin D was prepared as follows. The ingredients were weighed, and then blended by being tumbled together . The blend was then passed into a Buss Ko-Kneader PLK 46 extruder (barrel temperature 85° C.; screw temperature 85° C.; screw speed 52 rpm). The extrudate was cooled, crushed and sieved to a particle size not exceeding 100 μm.

Radiation cured polyester coating E was prepared as follows. The ingredients were weighed, and then blended by being tumbled together. The blend was then passed into a Buss Ko-Kneader PLK 46 extruder (barrel temperature 80° C.; screw temperature 80° C.; screw speed 250 rpm). The extrudate was cooled, crushed in a cutting mill and then finely ground in a pin mill before being sieved to a particle size not exceeding 100 μm.

### PREPARATIVE EXAMPLE 3

Thermoplastic powder coatings F and G having the formulations shown in Table 3 were produced as described below.

TABLE 3
Powder Coating Formulations

| | F. | G. |
|---|---|---|
| | Weight/kg | Weight/kg |
| Kynar 500PC | 10 | 10 |
| Acryloid B-44 | 4.8 | 4.8 |
| Kynar ADS | 1.1 | 1.1 |
| Irganox 1010 | 0.05 | 0.05 |
| Lanco wax TF1778 | 0.2 | 0.4 |

Kynar 500PC is a poly(vinylidene)fluoride polymer manufactured by Elf Atochem. Kynar ADS is a low melting point fluorine-based terpolymer also manufactured by Elf Atochem. Acryloid B-44 is a methyl methacrylate/ethyl acrylate copolymer manufactured by Rohm & Haas. Irganox 1010 is an anti-oxidant manufactured by Ciba Geigy.

The ingredients were weighed and blended by being tumbled together. The blend was extruded in a Werner and Pfleiderer extruder (Model ZSK-70) with the screw rotation set at 313 rpm, the barrel set at 200° C. and the feed zone set at 30° C. The extrudate was collected in large containers (of dimensions: 380 mm×305 mm×75 mm) and allowed to cool slowly at ambient temperature for 8 hours. The resulting blocks were broken into smaller pieces by mechanical attrition. The material was then ground in an Alpine Pin disc mill, using a single pass and no intermediate sieving screen. The temperature of the material prior to its introduction into the mill was −100° C.; the mill was maintained at −35° C. during grinding. 99% of the resulting powder was of a size of below 90 microns and the average powder size was 37 μm.

### EXAMPLE 4

Plastisol A was spread coated onto a substrate to a thickness of 2 mm by knife over roller. The substrate was a 2 m width cellulose/polyester support (Dexter 555:030) reinforced with a Kirson ‘5×5’ 68 tex glass crenneffe, moving at a rate of 5 m/minute. Particles of coloured quartz of a size of 1.2-1.8 mm were then scattered onto the surface of the plastisol at a rate of 300 gm⁻². The coated web was then passed under a 50 kW medium wave infra red heater (width 2.5 m; length 1 m). The heater was positioned at a height of 10 cm above the web. The power output of the heater was adjusted so that the surface of the plastisol as it exited the infra red zone was just solidified (gelled) to the touch.

Polyester based powder coating C, (average particle size 50 μm) was then applied to the surface at a rate of 80±30 g/m² using a scatter powder coating application system. Particles of silicon carbide size F40 (FEPA Standard 42-GB-1984 measurement) were then scattered on to the surface at a rate of 100 g/m². The system was then passed in to a convection oven where it was exposed to 185° C. for 2.5 minutes before being embossed, cooled and wound up for subsequent trimming to size.

### EXAMPLE 5

Plastisol B was spread coated onto a substrate to a thickness of 1 mm by knife over roller. The substrate was a 2 m width cellulose/polyester support (Dexter 555:030) reinforced with a Kirson ‘5×5’ 32 tex glass crennette moving at a rate of 7 metres/minute. Particles of coloured quartz of a size of 1.2-1.8 mm were then scattered on to the surface of the plastisol at a rate of 500 g/m². The system was then passed into a convection oven where it was exposed to 160° C. for 2 minutes. The system was then passed through a series of cooling rollers before it was over coated with more plastisol containing 10% by weight of aluminium oxide particles size F40 (FEPA Standard 42-GB-1984 measurement) to a total thickness of 2 mm by knife over bed.

Particles of PVC chip B were then scattered onto the surface of the plastisol at a rate of 50 g/m². The coated web was then passed under a 50 kW medium wave infra red heater (width 2.5 m; length 1 m). The heater was positioned at a height of about 10 cm above the web. The power output of the heater was adjusted so that the surface of the plastisol as it exited the infra red zone was just solidified to the touch. The power was then reduced so that the surface of the plastisol was not quite solidified (‘gelled’), but had very high viscosity.

An epoxy based clear coating powder D (average particle size 50 μm) was then applied to the surface at a rate of 80±30gm⁻² using a scatter powder coating application system. Particles of silicon carbide size F40 (FEPA Standard 42-GB-1984 measurement) were then scattered onto the surface at a rate of 100 gm⁻². The system was then passed in to a convection oven where it was exposed to 190° C. for 2.5 minutes before being embossed, cooled and wound up for subsequent trimming to size.

### EXAMPLE 6

Plastisol A was spread coated on a substrate to a thickness of 2 mm by knife over roller. The substrate was a 2 m width cellulose/polyester support (Dexter 555:030) reinforced with a Kirson ‘3×2’ 32 tex glass crennette moving at a rate of 3 metre/minute. Particles of coloured quartz of a size of 1.2-1.8 mm were then scattered on to the surface of the plastisol at a rate of 500 g/m². The coated web was then passed under a 50 kW medium wave infra red heater (width 2.5 m; length 1 m). The heater was positioned at a height of 10 cm above the web. The power output of the heater was adjusted so that the surface of the plastisol as it exited the infra red zone was fully solidified (‘gelled’) to the touch.

An acrylic based clear coating powder F, was then applied to the surface at a rate of 80±30 g/m² using a scatter powder coating application system. Particles of silicon carbide size F40 (FEPA Standard 42-GB-1984 measurement) were then scattered on to the surface at the rate of 100 g/m². The system was then passed in to a convection oven where it was exposed to 190° C. for 2 minutes before being embossed, cooled and wound up for subsequent trimming to size.

### EXAMPLE 7

Plastisol B was spread coated on a substrate to a thickness of 2 mm by knife over roller. The substrate was a 0.5 m width cellulose/polyester support (Dexter 555:030) reinforced with a Kirson ‘4×4’ 68 tex glass crennette, moving at a rate of 1.5 metre/minute. Particles of coloured quartz of a size of 1.2-1.8 mm were then scattered on to the surface of the plastisol at a nominal rate of 500 g/m². The coated web was then passed under a 4 kW medium wave infra red heater (width 0.6 m; length 0.4 m). The latter was positioned at a height of about 5 cm above the web. The power output was adjusted so that the surface of the plastisol as it exited the infra red zone was not quite solidified (‘gelled’) to the touch.

A radiation curable polyester powder coating E (average particle size 50 μm) was then applied to the surface at a rate of 80±30 g/m² using a scatter powder coating application system. Particles of silicon carbide size F24 (FEPA Standard 42-GB-1984 measured) were then scattered onto the surface at the rate of 100 g/m². The system was then passed in to a convection oven where it was exposed to 185° C. for 2 minutes. It was immediately embossed and irradiated by being passed under a Honle UVAPRINT 360 medium pressure mercury uv lamp positioned 3 cm above the web before being cooled.

### EXAMPLE 8

Plastisol A was spread coated on a substrate to a thickness of 2 mm by knife over roller. The substrate was a 0.5 m width cellulose/polyester support (Dexter 555:030) reinforced with a Kirson ‘4×4’ 68 tex glass crennette moving at a rate of 4 metres/minute. Particles of coloured quartz of a size of 1.2-1.8 mm were then scattered on to the surface of the plastisol at a rate of 400 g/m². The coated web was then passed under a 4 kW medium wave infra red heater (width 0.6 m; length 0.4 m). The latter was positioned at a height of about 5 cm above the web. The power output of the heater was adjusted so that the surface of the plastisol as it exited the infra red zone was not quite solidified (‘gelled’) to the touch.

A polyester powder coating C (average particle size about 50 μm) was then applied to the surface at a rate of 80±30 g/m² using a scatter powder coating application system. Particles of silicon carbide size F24 (FEPA Standard 42-GB-1984 measurement) were then scattered on to the surface at a rate of 100 g/m². The system was then passed in to a convection oven where it was exposed to 160° C. for 2 minutes before being embossed, and cooled. Further clear powder C was then applied at a rate of 80±30 g/m² using a scatter powder coating application system. The system was then passed in to a convection oven where it is exposed to 200° C. for 3 minutes before being embossed, and cooled.

### EXAMPLE 9

Plastisol A was spread coated on a substrate to a thickness of 2 mm by knife over roller. The substrate was a 2m width cellulose/polyester support (Dexter 555:030) reinforced with a Kirson ‘3×2’ 32 tex glass crennette moving at a rate of 3 metre/minute. Particles of coloured quartz of a size of 1.2-1.8 mm were then scattered on to the surface of the plastisol at a rate of 500 g/m². The coated web was then passed under a 50 kW medium wave infra red heater (width 2.5 m; length 1 m). The heater was positioned at a height of 10 cm above the web. The power output of the heater was adjusted so that the surface of the plastisol as it exited the infra red zone was fully solidified (‘gelled’) to the touch.

An acrylic based clear coating powder G, was then applied to the surface at a rate of 80±30 g/m² using a scatter powder coating application system. Particles of silicon carbide size F40 (FEPA Standard 42-GB-1984 measurement) were then scattered on to the surface at the rate of 100 g/m². The system was then passed in to a convection oven where it was exposed to 190° C. for 2 minutes before being embossed, cooled and wound up for subsequent trimming to size.

1. A slip resistant flooring material including a low surface tension additive to improve resistance to marking.

2. A flooring material according to claim 1 which includes a particulate material which is at least partially proud of an upper surface of the flooring material.

3. A flooring material according to claim 1 which is a plastics flooring material.

4. A flooring material according to claim 1 which includes a support.

5. A flooring material according to claim 1 which includes a base layer which includes PVC, a polyurethane, an epoxy resin, a plasticized acrylic, and/or a polyester.

6. A flooring material according to claim 5 wherein the base layer includes a plastics material such as a PVC plastisol or a plasticized acrylic material.

7. A flooring material according to claim 1 which is provided with a coating layer which forms an upper layer of the flooring material which coating layer comprises the additive.

8. A flooring material according to claim 7 wherein the coating layer includes a thermoplastic or a cross-linkable polymer or copolymer.

9. A flooring material according to claim 8 wherein the coating portion includes an acrylic polymer.

10. A flooring material according to claim 7 wherein the coating layer includes a particulate material which is at least partially proud of an upper surface of the coating layer and which penetrates a base layer.

11. A flooring material according to claim 1 wherein the additive is a wax or a silicone oil.

12. A flooring material according to claim 1 which comprises the additive in an amount from 0.1% to 4% by weight, more preferably from 0.2% to 2% by weight, most preferably about 2% by weight.

13. Deleted.

14. A method of manufacturing a slip resistant flooring material which method includes the steps of providing a base layer including a low surface tension additive; and curing the layer.

15. A method of manufacturing a slip resistant flooring material which method includes the steps of providing a base layer, applying a coating layer including a low surface tension additive, and heating the layers.

16. A method according to claim 15 which includes the step of increasing the viscosity of the base layer before the step of applying the coating layer.

17. A method according to claim 15 wherein the coating layer is applied as a powder.

18. A method according to claim 17 wherein the powder is manufactured by extrusion.

19. A method according to claim 17 wherein the low surface tension additive is incorporated into the coating layer by melt mixing at the extrusion stage or by blending it with the coating layer powder.

20. A method according to claim 19 wherein the particle size of the low surface tension additive is up to 30 μm.

21. A method according to claim 14 wherein the additive is sufficiently incompatible with the layer in which it is incorporated such that it migrates to the upper surface of the layer when the coating is heated.

22. A method according to claim 14 wherein the flooring material includes a particulate material which is partially proud of an upper surface of the flooring material to enhance the slip resistant properties of the flooring material.

23. Deleted.

24. A flooring material according to claim 8 wherein the coating layer includes a particulate material which is at least partially proud of an upper surface of the coating layer and which penetrates a base layer.

25. A flooring material according to claim 9 wherein the coating layer includes a particulate material which is at least partially proud of an upper surface of the coating layer and which penetrates a base layer.

26. A flooring material according to claim 2 which is a plastics flooring material.

27. A method according to claim 16 wherein the coating layer is applied as a powder.

28. A method according to claim 18 wherein the low surface tension additive is incorporated into the coating layer by melt mixing at the extrusion stage or by blending it with the coating layer powder.
